(19) United States
(12) Patent Application Publication
(10) Pub. No.: US 2021/0284821 A1
(43) Pub. Date: Sep. 16, 2021

(54) PIGMENT TREATED WITH AT LEAST ONE NON-REACTIVE POLYSILOXANE FOR USE IN THERMOPLASTICS

(71) Applicant: VENATOR UERDINGEN GMBH, KREFELD (DE)

(72) Inventors: GERHARD AUER, KREFELD (DE); HORST GUENNEL, KEMPEN (DE); BERND PROFT, NEUKIRCHEN-VLUYN (DE)

(73) Assignee: VENATOR UERDINGEN GMBH, KREFELD (DE)

(21) Appl. No.: 16/500,818

(22) PCT Filed: Mar. 29, 2018
(86) PCT No.: PCT/EP2018/058127

§ 371 Date: Oct. 4, 2019

(30) Foreign Application Priority Data
Apr. 5, 2017 (EP) 17165087.2

(51) Int. Cl. C08K 9/06; C08K 9/02; C08K 3/22; C08L 69/00; C09C 3/12; C09C 1/36

(52) U.S. Cl. CPC C08K 9/06; C08K 9/02; C08K 3/22; C08L 69/00; C09C 3/12; C09C 1/3692; C01P 2006/64; C09C 1/3661; C09C 1/3623; C08K 2003/2241; C01P 2004/84; C01P 2006/62; C09C 1/3684

(57) ABSTRACT

An inorganic pigment which is treated with at least one non-reactive polysiloxane of the general Formula I

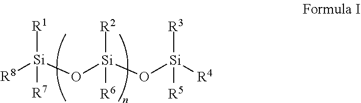

In general Formula I, R¹ to R⁸ are the same or different and are selected from CₘH₂ₘ₊₁, wherein m is ≤10, and fluorinated derivatives thereof wherein at least one hydrogen atom is replaced by fluorine, C₆H₅, and (EO)ₓ(PO)_{y} and copolymers thereof, wherein EO is an oxyethylene unit, PO is an oxypropylene unit, x and y are the same or different, and x+y is in the range of 1 to 50. The at least one non-reactive polysiloxane has a viscosity in the range of 50-3000 mm²×s⁻¹ at 25° C. The inorganic pigment treated with the at least one non-reactive polysiloxane of general Formula I has a residual moisture content of less than 1 wt-%.

### CROSS REFERENCE TO PRIOR APPLICATIONS

This application is a U.S. National Phase application under 35 U.S.C. § 371 of International Application No. PCT/EP2018/058127, filed on Mar. 29, 2018 and which claims benefit to European Patent Application No. 17165087.2, filed on Apr. 5, 2017. The International Application was published in English on Oct. 11, 2018 as WO 2018/184991 A1 under PCT Article 21(2).

### FIELD

The present invention relates to inorganic pigments treated/coated with at least one non-reactive polysiloxane, methods for producing the coated inorganic pigments, thermoplastics comprising the coated inorganic pigments, and methods for the production of the thermoplastics.

### BACKGROUND

Plastics can be divided into the main groups of thermoplastics and thermosets. Polymers that have a flow transition range above the working temperature are known as thermoplastics. Thermoplastics are linear or branched polymers which in principle are flowable above the glass transition temperature (Tg) in the case of amorphous thermoplastics and above the melting point (Tm) in the case of (partly) crystalline thermoplastics. The chain movability is so large that the polymer molecules slide easily over one another and the material reaches the molten state (flow range, polymer melt).

The properties of plastics can be controlled by the use of additives. One group of additives encompasses pigments, e.g., inorganic pigments that are responsible for the coloring. For improved compatibility, inorganic pigments are usually surface-modified. They are therefore coated to improve the stability of plastic articles or compounds with regard to polymer degradation. The polymer degradation can, for example, be recognized as a yellow color of the plastic articles or compounds after applying thermal stress during the extrusion/molding process or thermal stress during the lifetime of the plastic article.

Inorganic pigments can be surface-modified by inorganic coatings. Silicon dioxide and aluminum oxide are, for example, commonly used as an inorganic coating of a titanium dioxide pigment.

Inorganic pigments with or without an inorganic coating can, however, still adversely affect plastics, as these pigments often exhibit active sites on their surfaces. The prior art describes using organic coatings, e.g., antioxidants or octyltriethoxysilanes, for inorganic pigments to improve the stability of plastic materials.

Inorganic pigments are furthermore hygroscopic and thus contain water strongly bound to the surface with its active sites. The high residual moisture content also negatively influences the plastic properties and is regarded to be at least partly responsible for discoloration of the plastic.

Disadvantages of the inorganic pigments having organic coatings according to the prior art are that the organic additives used for coating react with the water traces bound to the pigment surface under condensation of reaction products like hydrogen. Other additives can, for example, lead to the formation of alcohol after subsequent thermal treatment. A further disadvantage is that the organic substances used for coating regularly do not meet requirements for materials intended to be in contact with food.

### SUMMARY

An aspect of the present invention is to provide an inorganic pigment that improves the stability of plastic articles or compounds with regard to polymer degradation, that avoids or reduces the formation of reaction products like hydrogen or alcohols during production, storage or application, and that allows storage stability also under humid conditions and thus does not have the disadvantages of the known inorganic pigments.

In an embodiment, the present invention provides inorganic pigments which are treated with at least one non-reactive polysiloxane of the general Formula I,

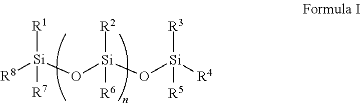

wherein R¹ to R⁸ may be the same or different and are selected from the group consisting of:

CₘH₂ₘ₊₁, wherein m is ≤10, for example, <6, for example, <4, and, for example, m=1, 2 or 3, and fluorinated derivatives thereof wherein at least one hydrogen atom is replaced by fluorine, such as CH₂CH₂CF₃,

C₆H₅,

(EO)ₓ(PO)_{y} and copolymers thereof, wherein EO represents an oxyethylene unit, PO represents an oxypropylene unit, x and y may be the same or different, and x+y is in the range of 1 to 50, and

wherein the at least one non-reactive polysiloxane has a viscosity in the range of 50-3000 mm²×s⁻¹ at 25° C., for example, 100-2000 mm²×s⁻¹ at 25° C., for example, 150-1000 mm²×s⁻¹ at 25° C., as determined according to DIN 51562, and

wherein the inorganic pigment treated with at least one non-reactive polysiloxane of the general Formula I has a residual moisture content of less than 1.0 wt-%, for example, less than 0.5 wt-%, for example, less than 0.4 wt-%, as determined by drying at 160° C. to a weight constancy.

### BRIEF DESCRIPTION OF THE DRAWINGS

The present invention is described in greater detail below on the basis of embodiments and of the drawings in which:

FIG. 1 shows the Lightness L* and Color b* values obtained for the sample as prepared in Example 1;

FIG. 2 shows the Lightness L* and Color b* values obtained for the sample as prepared in Example 2;

FIG. 3 shows the Lightness L* and Color b* values obtained for the sample as prepared in Example 3; and

FIG. 4 shows the Lightness L* and Color b* values obtained for the sample as prepared in Example 4.

### DETAILED DESCRIPTION

The inorganic pigments according to the present invention provide a surface on which the active sites are mostly covered by the at least one non-reactive polysiloxane accompanied by a low residual moisture content. Due to the treating or coating, the inorganic pigments show reduced hygroscopic properties which seem to be responsible for an improved storage stability, and the treatment leads to an improved stability of plastic articles containing these coated pigments. The low residual moisture content and the coverage of the active sites seem to be responsible for reduced polymer degradation, which is measured as a yellow color of the plastics due to thermal stress during the extrusion/molding process or during the lifetime of the plastic article containing the inorganic pigment. Other impacts on the properties of the plastics, which are impaired by polymer degradation like mechanical strength, are also reduced.

The inorganic pigment can be coated either with one kind of non-reactive polysiloxane or with a mixture of different kinds of non-reactive polysiloxanes of the general Formula I as shown above.

R¹ to R⁸ in the at least one non-reactive polysiloxane of the general Formula I can, for example, be the same or different and are selected from the group consisting of CₘH₂ₘ₊₁, wherein m is <6, for example, <4, and, for example, m=1 or 2. The at least one non-reactive polysiloxane can, for example, be a polydimethylsiloxane, for example, a FDA-approved polydimethylsiloxane, e.g., M350, which is a polydimethylsiloxane having a viscosity of 350 mm²×s⁻¹ at 25° C. These polydimethylsiloxanes meet the regulations for materials intended to have contact with foods and are thus in line with EU No 10/2011.

The at least one polysiloxane can, for example, be present in an amount of from 0.1 to 10 wt-%, for example, from 1 to 8 wt-%, for example, from 3 to 6 wt-% of the coated inorganic pigment, calculated on the total weight of the coated pigment according to carbon analysis after drying at 160° C. to weight constancy. It has been found that the degradation properties of the coated inorganic pigment according to the present invention rapidly decreases with an increasing amount of the at least one non-reactive polysiloxane. However, amounts of the at least one non-reactive polysiloxane of more than 3% per weight only slightly decreases the degradation properties further.

The inorganic pigment according to the present invention can be any inorganic pigment; the inorganic pigment can, for example, be selected from the group consisting of titanium dioxide, barium sulfate, zinc oxide and lithopone or mixtures thereof. The inorganic pigment can, for example, be rutile titanium dioxide.

The inorganic pigment according to the present invention can be organically or inorganically surface-modified with further compounds before treating with the at least one non-reactive polysiloxane of the general Formula I. According to the present invention, the inorganic pigment can also be pretreated with a reactive siloxane such as MH-15 having reactive Si—H moieties or other reactive polysiloxanes having Si—OR moieties in order to additionally silanize the surface of the pigment particles.

In an embodiment, the inorganic pigment can, for example, be a titanium dioxide pigment being treated with hydrated inorganic precursors of silicon dioxide and/or aluminum oxide and then treated with at least one non-reactive polysiloxane of the general Formula I.

In an embodiment, the coated pigment comprises reactive groups selected from —Si—H, or —Si—OR in an amount of less than 0.1 wt-%, for example, less than 0.01 wt-%, calculated on the total weight of the coated pigment and the added amount of organic additive after drying at 160° C. to weight constancy. Almost no reaction products such as hydrogen or alcohols during production, storage or application are thus formed.

The present invention also provides a method for producing a coated inorganic pigment according to the present invention comprising the step of treating an inorganic pigment with at least one non-reactive polysiloxane of the general Formula I or mixtures thereof,

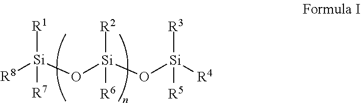

wherein R¹ to R⁸ may be the same or different and are selected from the group consisting of:

CₘH₂ₘ₊₁, wherein m is ≤10, for example, <6, for example, <4, and, for example, m=1, 2 or 3, and fluorinated derivatives thereof wherein at least one hydrogen atom is replaced by fluorine, such as CH₂CH₂CF₃,

C₆H₅,

(EO)ₓ(PO)_{y} and copolymers thereof, wherein EO represents an oxyethylene unit, PO represents an oxypropylene unit, x and y may be the same or different, and x+y is in the range of 1 to 50, and

wherein the at least one non-reactive polysiloxane has a viscosity in the range of 50-3000 mm²×s⁻¹ at 25° C., for example, 100-2000 mm²×s⁻¹ at 25° C., for example, 150-1000 mm²×s⁻¹ at 25° C., as determined by DIN 51562.

The treating step can, for example, be carried out at a temperature in the range of 100° C. to 450° C., for example, at a temperature in the range of 250° C. to 400° C. Due to the elevated temperature, water is driven out of the inorganic pigment and the surface of the inorganic pigment with its active sites is covered by the at least one non-reactive polysiloxane.

The treating step can also be carried out as a two-step or multi-step process in which the at least one non-reactive polysiloxane of the general Formula I is added to the pigment in several steps, which steps can each be interrupted by a milling step or a kneading step.

The method of the present invention makes it possible to produce coated inorganic pigments which can, for example, be selected from the group consisting of titanium dioxide, barium sulfate, zinc oxide and lithopone, for example, rutile titanium dioxide, or mixtures thereof.

In an embodiment, the inorganic pigment can, for example, be used in a pre-dried form having a residual moisture content of less than 1 wt-%, for example, less than 0.5 wt-%, for example, less than 0.4 wt-%, determined by drying at 160° C. to weight constancy. In the case of a pre-dried inorganic pigment, an elevated temperature during the treating of the inorganic pigment with at least one non-reactive polysiloxane of the general Formula I is not mandatory. According to the present invention, it is thus possible to treat the inorganic pigment thermally until a residual moisture content of less than 1.0 wt-%, for example, less than 0.5 wt-%, for example, less than 0.4 wt-%, determined by drying at 160° C. to weight constancy, is achieved, followed by treating the obtained inorganic pigment with the at least one non-reactive polysiloxane of the general Formula I. Due to the hygroscopic properties of the inorganic pigment itself, however, it must be provided that, in the period between the thermal treatment and the treating of the inorganic pigment with at least one non-reactive polysiloxane of the general Formula I, the moisture content does not increase over the limit as required.

In case the step of treating an inorganic pigment with at least one non-reactive polysiloxane of the general Formula I is carried out at elevated temperatures, it is thus possible to use an inorganic pigment as starting material that has a higher moisture content. The elevated temperatures leads to evaporation of the water, which is directly replaced by the at least on non-reactive polysiloxane.

According to the present invention, the step of treating the inorganic pigment with the at least one non-reactive polysiloxane of the general Formula I is carried out for less than 12 h, for example, less than 6 h, for example, less than 4 h, for example, between 0.25 to 2 h.

The thermal treatment can also be applied by microwave heating. By using microwaves, the drying time can be significantly reduced to a few minutes, but may lead to a deterioration of the color value b. Applying microwave heating should therefore be carried out under conditions with controlled energy impact.

In an embodiment, the treating can, for example, comprise milling and/or kneading. In an embodiment, only a partial amount of the at least one non-reactive polysiloxane can, for example, be added to the inorganic pigment before the milling step and/or kneading step, wherein the remaining amount of the at least one non-reactive polysiloxane is added during the further process. Such a partitioning of the at least one non-reactive polysiloxane can, for example, occur if a steam jet mill is used for milling and leads to increased yields of the coated inorganic pigment.

In an embodiment of the present invention, the inorganic pigment can, for example, be crushed down to a size of less than 1 mm, for example, to a size of less than 0.8 mm, for example, to a size of less than 0.6 mm, before being treated with the at least one non-reactive polysiloxane.

In an embodiment, the at least one non-reactive polysiloxane can, for example, be used in an amount so that a coated inorganic pigment comprising between 0.1 and 10 wt-%, for example, between 1 and 8 wt-%, for example, between 3 and 6 wt-% of the at least one polysiloxane, based on the total weight of the treated pigment after drying at 160° C. to weight constancy and calculated in accordance with a carbon analysis, is obtained.

The method of the present invention can, for example, comprise the step of adding at least one additive having reactive groups selected from silane-(Si—H) or C₁-C₁₂-alkoxy-siloxanes. Such coated inorganic pigments provide a further improved thermal stability. The silane-(Si—H) can be added before, together, or after the addition of the non-reactive polysiloxane.

The present invention further provides a thermoplastic comprising the inorganic pigment of the present invention.

Thermoplastics which can be used in the process of the present invention include thermoplastically workable plastics having pronounced entropy-elastic properties. Thermoplastics also include all plastics consisting of linear or thermolabile cross-linked polymer molecules, for example, polyolefins, vinyl polymers, polyesters, polyacetals, polycarbonates, also polyurethanes, ionomers, and thermoplastic elastomers such as acrylnitrile-butadiene-styrene (ABS), polyamide (PA), polylactate (PLA), polymethylmethacrylate (PMMA), polycarbonate (PC), polyethylene terephthalate (PET), polyethylene (PE), polypropylene (PP), polystyrene (PS), polyether etherketone (PEEK), polyvinylchloride (PVC), PBT polybutylene terephthalate as well as baking enamels for powder coating.

The thermoplastic can, for example, comprises polycarbonate.

The present invention further provides a method for the production of a thermoplastic comprising adding a pigment according to the present invention to a thermoplastic polymer, mixing the polymer mixture, and subjecting the obtained polymer mixture to a plastics forming process, for example, an injection molding process, a compression molding process, a pressing process, or an extrusion process.

The polymer mixture can, for example, be dried at a temperature in the range of 80° C. to 200° C. for 1-10 h before the plastics forming process.

In an embodiment, the plastic production process can, for example, be carried out at a temperature in the range of 200° C. to 450° C., for example, in the range of 280° C. to 370° C.

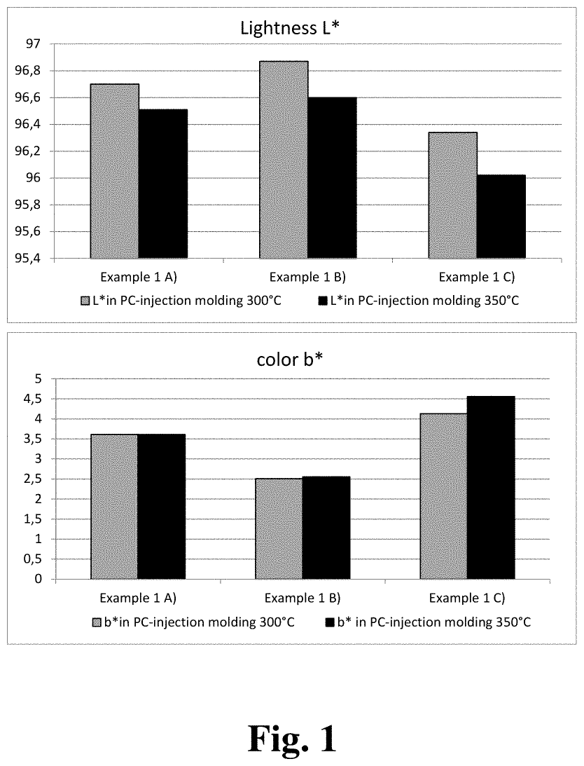

The attached FIGS. 1 to 4 illustrate the Lightness L* and Color b* values obtained for the samples as prepared in Examples 1 to 4, respectively.

### Experimental Part

### Measuring Methods

The methods for determining properties of the coated pigments were as follows.

A mixture of 5% of the coated pigment in Macrolon® 3108 powder was dried for 5 hours at 120° C. The dried mixture was processed on an Arburg 221 injection molder at 300° C. and 350° C., respectively, giving white polycarbonate plates. The optical properties Lightness L* and color b* (according to the CIELab color system) of the molded plates were determined with a Hunterlab UltraScan VIS spectrophotometer applying a light source D 65 using a 10° observer with gloss included.

The content of the organic coating on a pigment was determined by carbon analysis of the pigment using an ELTRA CS2000 analyzer and calculation of the total organic coating out of it according to the share of carbon in the organic applied. For this purpose, the probe was combusted at 1100° C. in an oxygen stream and the formed CO₂ was passed through in an infrared cell for detection.

The water content of the particles, especially after drying, was calculated via the Karl-Fischer titration method.

The content of reactive groups such as —Si—H moieties was measured by alkaline hydrolysis and volumetric determination of the formed hydrogen gas.

The particle size of the particles was determined by sieving analysis.

All weight percentages refer to the total weight of the treated pigment after drying to weight constancy at 160° C. Such drying can be carried under air or protective atmosphere.

The present invention is further illustrated by the following Examples 1 to 4 which are further illustrated in the attached FIGS. 1 to 4 referring to the respective Example of the same number.

### Example 1

A)

Micronized rutile titanium dioxide pigment treated with alumina (RKB3) was dried at 130° C. The dry residue was crushed to particles having a diameter of below 1 mm. These particles were sprayed with 0.5 wt-% M350 (20 g M350/4 kg dry residue) and heated for 1 h at 350° C. in a rotary kiln. The particles were subsequently treated in a steam jet mill (steam/product relation 3.0, 20 kg/h entry, 40 kg/h mill-steam), whereby only a low dust formation was observed. The milled product (5.14 kg) was homogenized in a Lödige mixer, whereby a further 200 g M350 (3.9%) was added. Approximately 5.3 kg of an inorganic pigment coated with a non-reactive polysiloxane and a residual moisture content of 0.6% according to the present invention was obtained.

B)

Micronized rutile titanium dioxide pigment treated with alumina (RKB3) was dried at 130° C. The dry residue was crushed to particles having a diameter of below 1 mm. These particles were sprayed with 0.5 wt-% M350 (20 g M350/4 kg dry residue). The particles were treated in a steam jet mill (steam/product relation 3.0, 20 kg/h entry, 40 kg/h mill-steam). The milled product (5.51 kg) was homogenized in a Lödige mixer, whereby a further 200 g M350 (3.6%) was added. The product was heated for 1 h at 350° C. in a rotary kiln. Approximately 5.51 kg of an inorganic pigment coated with a non-reactive polysiloxane and a residual moisture content of 0.3% according to the present invention was obtained as a granulate having an particle diameter of approximately 1-2 mm.

C)

Micronized rutile titanium dioxide pigment treated with alumina (RKB3) was dried at 130° C. The dry residue was crushed to particles having a diameter of below 1 mm. These particles were sprayed with 3 wt-% M350 (120 g M350/4 kg dry residue) and heated for 1 h at 350° C. in a rotary kiln. The product (8.02 kg) was milled in a steam jet mill (steam/product relation 3.0, 20 kg/h entry, 40 kg/h mill-steam). Approximately 6.03 kg of an inorganic pigment coated with a non-reactive polysiloxane and a residual moisture content of 0.4% according to the present invention was obtained.

The following processes include mixing of polycarbonate powder Macrolon® 3108 (PC) and the obtained pigment powder (5%) of Examples 1 A), B) and C), respectively, drying of the mixture at 120° C. for 5 h, and subsequently subjecting the mixture to an injection molding process at 300 and 350° C. Optical properties of polycarbonate (PC) plates containing the pigments according to Example 1 A), B) and C) were analyzed and shown in FIG. 1.

### Example 2

Optical properties of polycarbonate (PC) plates containing pigments RFK3 with organic treatment M350 (Example 2 A) and octyltriethoxysilane (Example 2 B), respectively, and subsequent thermal treatment at 350° C. (0.5 h) before injection molding, were analyzed.

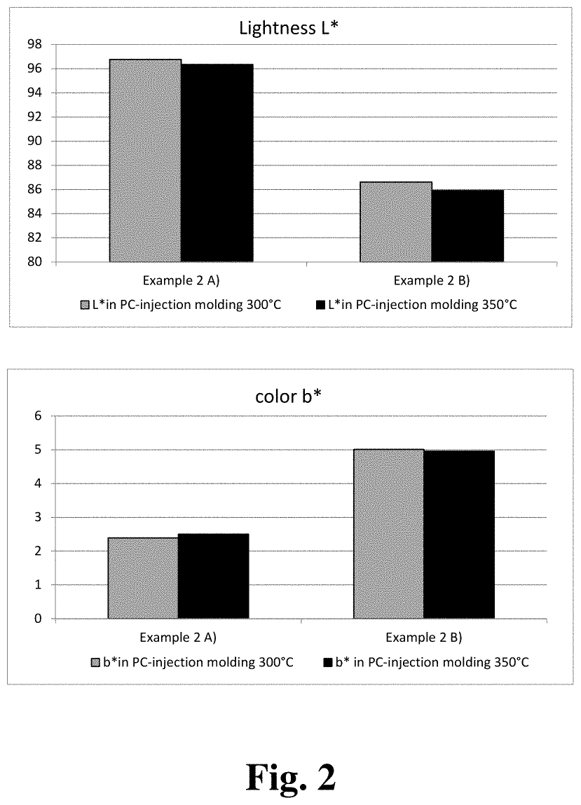

The following processes include the mixing of polycarbonate powder Macrolon® 3108 (PC) and the pigment powder (5%) containing M350 and octyltriethoxysilane, respectively, drying of the mixture at 120° C. for 5 h and subsequently subjecting the mixture an injection molding process at 300 and 350° C. The resulting plates were analyzed regarding optical properties Lightness L* and color b*. M350, compared to octyltriethoxysilane, leads to higher L* and lower b* values at test temperatures 300 and 350° C. as shown in FIG. 2.

### Example 3

Optical properties of PC plates containing pigments RKB3 with increasing amount of organic treatment M350 with 0.0, 2.0, 3.0 and 4% (Examples 3 A) to 3 D)), respectively, and subsequent thermal treatment at 350° C. followed by an injection molding process, were analyzed.

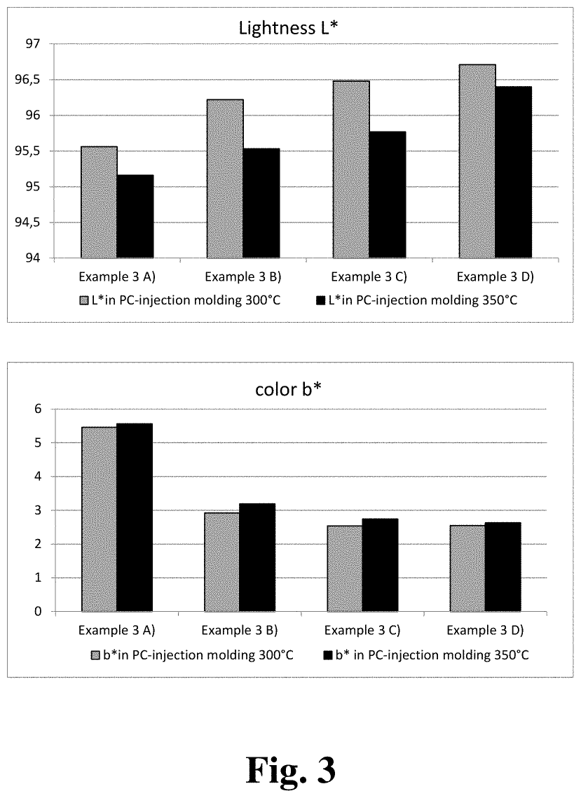

The injection molding process includes mixing polycarbonate powder Macrolon® 3108 (PC) and the pigment powder (5%), drying of the mixture at 120° C. for 5 h and subsequently subjecting the mixture an injection molding process at 300 and 350° C., respectively. The resulting plates were analyzed regarding optical properties Lightness L* and color b* and shown in FIG. 3. An increasing amount of organic treatment increases L* and decreases color b* at test temperatures 300 and 350° C., respectively.

### Example 4

Optical properties of PC plates containing pigments RKB3 with organic treatment M350 (3%, Example 4 A)) and subsequent thermal treatment at 350° C. and microwave (1 min. 800 W/50 g, Example 4 B)), respectively, followed by an injection molding process, were analyzed.

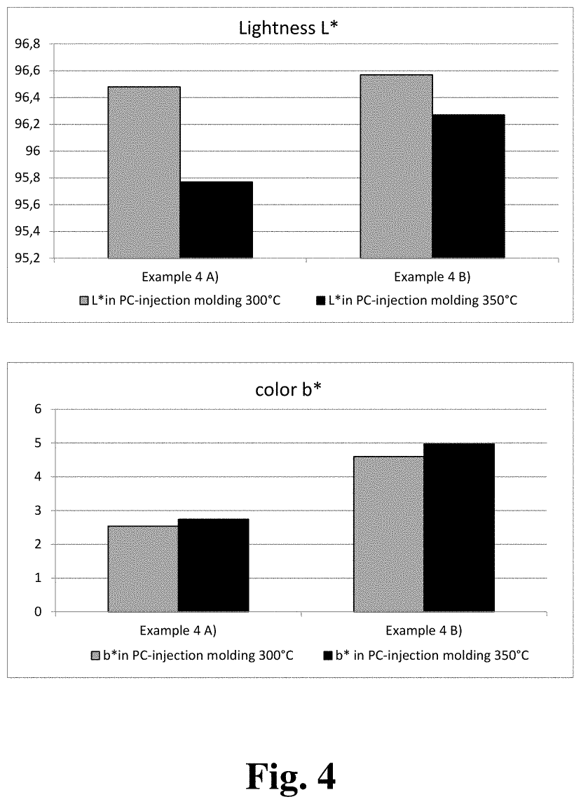

The injection molding process includes mixing of polycarbonate powder Macrolon® 3108 (PC) and the pigment powder (5%), drying of the mixture at 120° C. for 5 h, and subsequently subjecting the mixture an injection molding process at 300 and 350° C., respectively. The resulting plates were analyzed regarding optical properties Lightness L* and color b* and shown in FIG. 4. Microwave heating leads to higher L* and higher b* at test temperatures 300 and 350° C., compared to thermal treatment at 350° C.

The present invention is not limited to embodiments described herein; reference should be had to the appended claims.

What is claimed is:

1-15. (canceled)

16. An inorganic pigment treated with at least one non-reactive polysiloxane of the general Formula I, 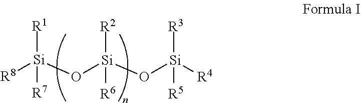
wherein,
R¹ to R⁸ are the same or different and are selected from the group consisting of:
CₘH₂ₘ₊₁, wherein m is ≤10, and fluorinated derivatives thereof wherein at least one hydrogen atom is replaced by fluorine,
C₆H₅, and
(EO)ₓ(PO)_{y} and copolymers thereof, wherein EO is an oxyethylene unit, PO is an oxypropylene unit, x and y are the same or different, and x+y is in the range of 1 to 50,
the at least one non-reactive polysiloxane has a viscosity in the range of 50-3000 mm²×s⁻¹ at 25° C. as determined by DIN 51562, and
the inorganic pigment treated with the at least one non-reactive polysiloxane of general Formula I has a residual moisture content of less than 1 wt-% after drying at 160° C. to a weight constancy.

17. The inorganic pigment as recited in claim 16, wherein,
R¹ to R⁸ may be the same or different and are selected from the group consisting of CₘH₂ₘ₊₁, and
m is <6.

18. The inorganic pigment as recited in claim 16, wherein the at least one non-reactive polysiloxane is polydimethylsiloxane.

19. The inorganic pigment as recited in claim 16, wherein the at least one polysiloxane is present in an amount of from 0.1 to 10 wt-% of the treated inorganic pigment, calculated on a total weight of the treated inorganic pigment after the drying at 160° C. to the weight constancy.

20. The inorganic pigment as recited in claim 16, wherein the inorganic pigment is selected from the group consisting of titanium dioxide, barium sulfate, zinc oxide, lithopone, or mixtures thereof.

21. The inorganic pigment as recited in claim 20, wherein the titanium dioxide is rutile titanium dioxide.

22. The inorganic pigment as recited in claim 16, wherein the inorganic pigment comprises reactive groups selected from —Si—H or —Si—OR in an amount of less than 0.1 wt-% calculated on a total weight of the treated inorganic pigment after the drying at 160° C. to the weight constancy.

23. The inorganic pigment as recited in claim 15, wherein the inorganic pigment is pretreated inorganically or organically.

24. A method for producing an inorganic pigment treated with at least one non-reactive polysiloxane of the general Formula I as recited in claim 16, the method comprising:
treating an inorganic pigment with at least one non-reactive polysiloxane of the general Formula I, 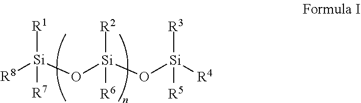
wherein,
R¹ to R⁸ are the same or different and are selected from the group consisting of:
CₘH₂ₘ₊₁, wherein m is ≤10, and fluorinated derivatives thereof wherein at least one hydrogen atom is replaced by fluorine,
C₆H₅, and
(EO)ₓ(PO)_{y} and copolymers thereof, wherein EO is an oxyethylene unit, PO is an oxypropylene unit, x and y are the same or different, and x+y is in the range of 1 to 50, and
the at least one non-reactive polysiloxane has a viscosity in the range of 50-3000 mm²×s⁻¹ at 25° C. as determined by DIN 51562.

25. The method as recited in claim 24, wherein the treating is performed at a temperature in a range of from 100° C. to 450° C.

26. The method as recited in claim 24, wherein the treating of the inorganic pigment with the at least one non-reactive polysiloxane of the general Formula I is performed for less than 12 h.

27. The method as recited in claim 24, further comprising at least one of milling and kneading.

28. An inorganic pigment treated with the at least one non-reactive polysiloxane of the general Formula I which is obtainable by the method as recited in claim 24.

29. A thermoplastic comprising the inorganic pigment treated with the at least one non-reactive polysiloxane of the general Formula I as recited in claim 16.

30. The thermoplastic as recited in claim 29, wherein the thermoplastic further comprises polycarbonate.

31. A method for the production of a thermoplastic, the method comprising:
adding the inorganic pigment treated with the at least one non-reactive polysiloxane of the general Formula I as recited in claim 16 to a thermoplastic polymer so as to obtain a polymer-pigment combination;
mixing the polymer-pigment combination so as to obtain a mixed polymer-pigment combination; and
subjecting the mixed polymer-pigment combination to a plastics forming process.

32. The method as recited in claim 31, wherein the plastics forming process is an injection molding process, a compression molding process, a pressing process or an extrusion process.

33. The method as recited in claim 31, wherein the method is performed at a temperature in a range of from 200° C. to 450° C.
